(19) United States
(12) Patent Application Publication
(10) Pub. No.: US 2026/0125585 A1
(43) Pub. Date: May 7, 2026

(54) Two-Component Rapid Cure Adhesive

(71) Applicant: Zephyros, Inc., Romeo, MI (US)

(72) Inventors: Ira Miller, Romeo, MI (US); Michael Czaplicki, Romeo, MI (US)

(21) Appl. No.: 18/854,788

(22) PCT Filed: Apr. 25, 2023
(86) PCT No.: PCT/US2023/019775

§ 371 Date: Oct. 7, 2024

Related U.S. Application Data
(60) Provisional application No. 63/334,350, filed on Apr. 25, 2022.

(51) Int. Cl. C09J 163/04; C08G 59/40; C08K 3/22; C08K 3/26; C08K 3/36

(52) U.S. Cl. CPC C09J 163/04; C08G 59/4071; C08K 3/36; C08G 2170/00; C08K 2003/2227; C08K 2003/265; C08K 2201/019

(57) ABSTRACT

The present teachings provide for an adhesive formulation comprising a part A with an epoxy resin, and a part B with an acidic phosphorous constituent, wherein the adhesive has a T-Peel of at least about 2.5 N/mm as measured in accordance with ASTM D1876.

### FIELD

The present teachings relate generally to rapid curing ambient temperature cured 2-component adhesives containing some epoxide functionality while providing improved T-Peel resistance, and adhesion to a range of substrates. The invention employs the use of phosphoric acid and/or phosphate esters and/or other acidic constituents as the primary activator and curing agent to be reacted with a mixture containing epoxide functional materials as the primary co-reactant.

### BACKGROUND

Rapid setting epoxy adhesives, including the category of products referred to as 5-minute epoxies are well known commercially. Generally, they cure quickly, but are not known to have an attractive aggregate property set. To date, there has been a significant trade-off of fast reaction time in exchange for physical property reduction and compromised durable adhesion to a variety of substrates. Various curing agents, hardeners, or activators have been used to create these adhesives commonly found in hardware stores and DIY centers. Although adhesives can be made with high shear strength, their use as assembly adhesives in manufacturing and durable repair solutions is limited due to their lack of peel resistance with one common evaluation method being the T-Peel test. This lack of peel resistance limits uses where bending, peeling, and off-axis loading might be important factors. In addition, adhesion quality varies typically for a range of substrates with inconsistent lap shear strength per substrate type as a manifestation of this phenomenon.

Notwithstanding the above teachings, there remains a need for rapid cure adhesives with an appropriate blend of particulate tougheners and flexibilizers such that the right blend of an immiscible elastomeric toughening phase with sufficient matrix plasticization results in improved physical characteristics.

The present teachings provide one or more of the above-mentioned benefits. The adhesive materials of the present teachings may be utilized to provide a rapid cure adhesive with one or more of improved peel resistance, improved lap shear and improved adhesion over a variety of substrates, including when contamination is present.

### SUMMARY

The present teachings provide for an adhesive comprising a part A with an epoxy resin, and a part B with an acidic phosphoric constituent. The cured adhesive has a T-Peel of at least about 2.5 N/mm as measured in accordance with ASTM D1876.

The teachings herein are further directed to a curable adhesive formulation comprising a part A with one or more epoxy resins, and a part B with an acidic phosphoric constituent. The adhesive includes one or more of calcium carbonate, minerals, reinforcing fibers, hydrophobic silica, or any combination thereof.

The teachings herein are further directed to a curable adhesive formulation comprising a part A with one or more epoxy resins, and a part B with an acidic phosphoric constituent. The cured adhesive has a T-Peel of at least about 2.5 N/mm as measured in accordance with ASTM D1876.

The cured adhesive may provide for assemblies that have a lap shear of at least about 15 MPa as measured in accordance with EN 2243-1.

The acidic phosphoric constituent may comprise one or more phosphate esters, phosphoric acid, polyphosphoric acid, phosphorus pentoxide, or any combination thereof. The one or more phosphate esters may include a first phosphate ester, a second phosphate ester, a third phosphate ester, or any combination thereof.

The one or more phosphate esters independently of one another may be the reaction products of phosphoric acid and: an alcohol; an epoxide group of a phosphate ester precursor (i.e., component not yet reacted with phosphoric acid); a mono-epoxide functional molecule; a glycidyl ether of cashew nutshell liquid (CNSL); a phenyl glycidyl ether; 2-ethylhexyl glycidyl ether; and/or an epoxidized para-tertiary butyl phenol.

The one or more phosphate esters may be present in an amount of about 0.1% to about 30% by weight of the B-side; preferably about 10% to about 14% by weight of the B-side. The at least one phosphate ester may be present in an amount of from about 10% to about 60% by weight of the B-side; preferably about 25% to about 35% by weight of the B-side; more preferably about 28% to about 32% by weight of the B-side. The at least one phosphate ester may be present in an amount of from about 5% to about 40% by weight of the B-side; preferably about 15% to about 25% by weight of the B-side; more preferably about 18% to about 22% by weight of the B-side. The at least one phosphate ester may be present in an amount of from about 10% to about 65% by weight of the B-side; preferably about 35% to about 45% by weight of the B-side.

Part B may comprise one or more non-phosphorous containing acids or derivatives, one or more acid anhydride, one or more additives, one or more monomers, or any combination thereof.

The one or more additives may include, minerals, reinforcing fibers, fumed silica, or any combination thereof. The adhesive may include calcium carbonate. The adhesive may include an elastomeric material. The adhesive may include one or more of calcium carbonate, minerals, reinforcing fibers, hydrophobic silica, or any combination thereof.

The two-part system may include calcium carbonate present in an amount of from about 1% to about 25% by weight of the part A; preferably about 4% to about 18% by weight of the A-side; more preferably about 8% to about 12% by weight of the A-side.

The two-part system may include a core shell material. The two-part system may include hydrophobic silica. The two-part system may include tabular alumina.

The one or more epoxy resins may include one or more liquid epoxy resins, one or more flexible epoxy resins, one or more epoxy phenol novolac resins, one or more aliphatic multifunctional epoxy resins, one or more reactive diluents, one or more silane modified epoxy resins, or any combination thereof.

The adhesive of any of the preceding claims, wherein the one or more epoxy resins include one or more liquid epoxy resins.

The adhesive of claim 21, wherein the one or more liquid epoxy resins independently of one another are a reaction product of epichlorohydrin and a bisphenol; preferably, bisphenol A, bisphenol F, or both.

The one or more liquid epoxy resins may have: an epoxide equivalent weight of from about 100 g/equivalent to about 1000 g/equivalent as measured according to ASTM D1652-97; an epoxide percentage of from about 20 to about 25; and/or a viscosity of from about 10 cP to about 100,000 cP at 25° C. as measured according to ASTM D445. The one or more liquid epoxy resins may be present in an amount of from about 4% to about 50% by weight of the A-side. The one or more liquid epoxy resins may be present in an amount of from about 10% to about 30% by weight of the A-side. The one or more liquid epoxy resins may be present in an amount of about 8% by weight of the A-side.

The one or more epoxy resins may include one or more flexible epoxy resins; preferably independently of one another selected from di-functional glycidyl ether epoxy resin, modified BPA-based epoxy resins, multifunctional epoxidized polybutadiene resins, or any combination thereof. The one or more flexible epoxy resins independently of one another may have: an epoxide equivalent weight of about 260 to about 500 as measured according to ASTM D1652-97; and/or a viscosity of about 700 cP to about 500,000 cP at 25° C. as measured according to ASTM D445. The one or more flexible epoxy resins may be present in an amount of from about 10% to about 50% by weight of the A-side; preferably about 35% to about 45% by weight of the A-side. The one or more flexible epoxy resins may include a di-functional glycidyl ether epoxy resin in the amount of from about 10% to about 18% by weight of the A-side, an unmodified BPA-based epoxy resin in an amount of from about 8% to about 16% by weight of the A-side, and a multifunctional epoxidized polybutadiene resin in an amount of from about 8% to about 16% by weight of the A-side.

The one or more epoxy resins may include one or more epoxy phenol novolac resins. The one or more epoxy phenol novolac resins may have an epoxide equivalent weight of from about 165 g/equivalent to about 183 g/equivalent as measured according to ASTM D1652-97; an average epoxy functionality of from about 2.1 to about 6.5; and/or a viscosity of from about 18,000 cP to about 30,000 cP at 25° C. as measured according to ASTM D445.

The one or more epoxy phenol novolac resins may be present in an amount of from about 30% to about 50% by weight of the A-side; preferably about 35% to about 45% by weight of the first component or A-side; more preferably about 38% to about 42% by weight of the A-side.

The one or more epoxy phenol novolac resins may include an about 3.6 functional epoxy phenol novolac resin present in an amount of from about 2% to about 18% by weight of the A-side and an about 6.5 functional epoxy novolac resin present in an amount of from about 22% to about 32% by weight of the A-side; an about 3.6 functional epoxy phenol novolac resin present in an amount of about 15% by weight of the A-side and an about 6.5 functional epoxy novolac resin present in an amount of about 28% by weight of the A-side; and/or an about 3.6 functional epoxy phenol novolac resin and an about 6.5 functional epoxy phenol novolac resin at a ratio of about 1:2 to about 1:3.

The one or more epoxy resins may include one or more aliphatic multifunctional epoxy resins; preferably epoxidized sorbitol. The one or more aliphatic multifunctional epoxy resins may have an epoxide equivalent weight of from about 160 g/equivalent to about 195 g/equivalent as measured according to ASTM D1652-97; and/or a viscosity of from about 200 cP to about 18,000 cP at 25° C. as measured according to ASTM D445. The one or more aliphatic multifunctional epoxy resins may be present in an amount of from about 5% to about 20% by weight of the A-side; preferably 8% to about 16% by weight of the A-side; more preferably about 10% to about 14% by weight of the A-side.

The one or more epoxy resins may include cashew nutshell liquid; preferably a glycidyl ether of the cashew nutshell liquid; more preferably a glycidyl ether of cardanol. The one or more epoxy resins may include one or more reactive diluents; preferably a polyglycol diglycidyl ether, a trimethylolethane triglycidyl either, or both. The one or more reactive diluents may be present in an amount of from about 5% to about 20% by weight of the A-side; preferably about 8% to about 16% by weight of the A-side; more preferably about 10% to about 14% by weight of the A-side.

The one or more epoxy resins may include one or more epoxy functional silane or silane modified epoxy resins. The one or more silane modified epoxy resins may be present in an amount of about 1% to about 15% by weight of the A-side; preferably about 2% to about 6% by weight of the A-side; more preferably about 4% by weight of the A-side.

The cured adhesive may provide for assemblies that have a lap shear of at least about 15 MPa as measured in accordance with EN 2243-1. The adhesive may include calcium carbonate. The adhesive may include an elastomeric material. The adhesive may include one or more of calcium carbonate, minerals, reinforcing fibers, hydrophobic silica, or any combination thereof. The adhesive may include calcium carbonate present in an amount of from about 2% to about 25% by weight of the part A. The adhesive may include a core shell material. The adhesive may include one or more liquid epoxy resins including a reaction product of epichlorohydrin and bisphenol A. The cured adhesive may have a tensile modulus of at least 1000 MPa as measured in accordance with ISO 527.

The part A may include an epoxidized linseed oil. Any component in part B may not physically separate from the acidic phosphorus constituent. Part A and part B may be substantially free of any fiber material. The epoxy resin may include an aliphatic epoxy resin. Part A may include an epoxidized linseed oil in an amount of greater than 0.5% but less than 10%. Part A may include an epoxidized linseed oil in an amount of greater than 1% but less than 6%. Part A may include a bisphenol A epoxy resin in an amount of at least 0.5%.

Part A may include a bisphenol A epoxy resin in an amount of at least 2.5%. Part A may include bisphenol A epoxy and an epoxidized linseed oil in a ratio of from about 1 part bisphenol A epoxy:2 parts epoxidized linseed oil to from about 2 parts bisphenol A epoxy:about 1 part epoxidized linseed oil. Part A may include bisphenol A epoxy and an epoxidized linseed oil in a ratio of from about 1 part bisphenol A epoxy:1 part epoxidized linseed oil. Part A may include a di-functional glycidyl ether epoxy resin and an epoxidized linseed oil in a ratio of from about 3 parts a di-functional glycidyl ether epoxy resin:about 1 parts epoxidized linseed oil. The part A and part B may be present in a ratio of about 4 parts part A to about 1 part part B.

The adhesive may cure at ambient temperature (about 20° C. to about 23° C.). The speed at which the adhesive cures may be increased with the addition of heat.

The teachings herein are further directed to a method of adhering a first substrate to a second substrate including locating the adhesive onto the first substrate and locating the second substrate into contact with the adhesive within 5 minutes. The part A of the adhesive may be mixed with part B of the adhesive within 5 minutes of locating the adhesive onto the first substrate.

### DETAILED DESCRIPTION

The present teachings meet one or more of the above needs by the improved compositions and methods described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

This application claims the benefit of the filing date of U.S. Provisional Application Ser. No. 63/334,350, filed on Apr. 25, 2022. The contents of that application are incorporated by reference herein in their entirety and for all purposes.

The following teachings describe significantly improved overall performance of rapid curing adhesives via a novel, non-traditional curative system. For example, crosslinked epoxy resins, manufactured from traditional epoxy resins, are known for their strength and stiffness, but are often brittle i.e., low strain to failure materials with poor impact resistance. This characteristic can produce adhesives with high shear strength when bonding metal substrates, but poor peel resistance and low fracture toughness. Low fracture toughness of these systems influences the typically low peel resistance. No one constituent is responsible solely for improved peel resistance. It may be the result of multiple constituents and interactions, although the novel curative system used for these product types may be important to maintain reaction speed while obtaining improved peel resistance.

The teachings herein further describe the use of phosphoric acid and/or phosphate esters and or other acidic constituents such as carboxylic acids and acid anhydrides as the primary activator to make 2-component (A side and B side), ambient temperature cured adhesives. The adhesives may have some epoxide functionality, improved T-Peel resistance, and adhesion to a variety of substrates. A key criterion is that the additional components in the curative side (B side) must be compatible with phosphoric acid or phosphate esters and not physically separate from the acid or phosphate esters. Acids in general, or any molecule that can easily de-protonate, are known to initiate ring-opening in epoxy resins and subsequent polymeric advancement and cross-linking. The resulting increase in molecular weight is fundamental to the mechanical and adhesive properties of the final product. Molecules with an average functionality greater than 2, whether they are proton liberating molecules, epoxy functional molecules, or any combination of the two, are capable of creating a 3-dimensional crosslinked network when reacted through their functional groups.

The A-side may comprise one or more epoxy resins, one or more additives, one or more monomers, or both. The one or more epoxy resins may include one or more liquid epoxy resins, one or more flexible epoxy resins, one or more epoxy phenol novolac resins, one or more aliphatic multifunctional epoxy resins, one or more reactive diluents, one or more silane modified epoxy resins, one or more monomers, or any combination thereof. The one or more additives may include one or more toughening agents (e.g., core-shell polymeric particles), metal carbonates, minerals, reinforcing fibers, fumed silica, tabular alumina, or any combination thereof.

The B-side may comprise one or more phosphate esters, phosphoric acid, polyphosphoric acid, phosphorus pentoxide, one or more non-phosphorous containing acids or derivatives, one or more acid anhydride, one or more additives, one or more monomers, or any combination thereof. The one or more phosphate esters may include a first phosphate ester, a second phosphate ester, a third phosphate ester, or any combination thereof. The one or more additives may include, minerals, reinforcing fibers, fumed silica, or any combination thereof.

Phosphoric acid works well for the initiation and propagation of epoxy crosslinking. However, there are difficulties in using this acid as the sole curative for some types of formulated products. Because of its low molecular weight and high functionality compared to most common epoxy molecules, the volumetric mix ratio between resin and curative can be too disparate. Typically, mix ratios of 1:1 are most preferred in many instances because of their ease of handling and generally increased tolerance for off-ratio mixing. Mix ratios of 2:1, 4:1, even 10:1 can be acceptable, but higher mix ratios make more precise dosing of the inferior component necessary.

The high functionality and low pH of phosphoric acid also contributes to rapid speed of reaction. In an automated process, a rapid curing, less than 5-minute curing, adhesive may be desirable. However, for most manual assembly processes, a certain amount of time is required for mixing and the application of the adhesive and subsequent assembly of the parts. Additionally, as mentioned earlier, fast curing adhesives have performance trade-offs. The reduced performance is in part due to the reduced wetting time of the adhesive. That is, the reduced time the adhesive has to create intimate contact with the substrates before molecular weight increase and subsequent crosslinking begins. Rapid viscosity build also can be an impediment to developing adhesion. Similarly, rapid reaction rates reduce the time available for phase separation of discrete secondary phases that can be useful for physical property improvement, particularly for the purpose of increasing peel resistance, as will be discussed with epoxidized carboxyl-terminated acrylonitrile-butadiene rubber.

Because of the rapid speed of bond formation from crosslinking of the epoxy resin, a high peak exotherm may be generated if there is sufficient material mass. The same amount of energy may be liberated from the system curing slower, but the heat would have more time to dissipate or transfer into the substrates, surrounding materials, or air, reducing the peak exotherm.

U.S. Pat. No. 6,730,713 describes a material comprising an epoxy resin, phosphoric acid, and a metal carbonate for forming a foam-in-place material and WO 2016/149700 describes an esterified acid for use in polymeric materials. The teachings herein describe structural adhesives with improved T-Peel resistance and desirable adhesion to multiple substrate types. Although some of the following teachings describe a non-foaming, or minimally foaming material, a material with a final density similar to a combination of the densities of the two initial components, a more highly foaming material may be made where the final density is significantly less than a combination of the densities of the two initial components.

Pre-reacting phosphoric acid with an epoxy functional molecule, as described in WO 2016/149700, can eliminate, or reduce many of the difficulties associated with using concentrated phosphoric acid as the sole curative. The higher molecular weight molecule with reduced reactivity will react more slowly and have fewer reactive functional groups per unit volume, reducing the peak exotherm of the reaction mixture. The combination of higher molecular weight and reduced reactivity may also affect the volumetric mix ratio between the epoxy resin and curative, enabling it to be closer to 1:1. In addition, the reaction product of phosphoric acid and epoxy is more viscous than phosphoric acid alone. This will typically match the viscosity of the epoxide functional side more closely and enable better mixing of the two. Also, material performance and properties can be tuned through the selection of the epoxy functional molecule used to pre-react with the phosphoric acid, allowing material properties to be obtained from a combination of both the resin and curative components of the adhesive. These attributes of using phosphoric acid and or esters of phosphoric acid enable the creation of adhesives that react quickly and yet adhere to a broad range of substrates.

Phosphoric acid and or esters of phosphoric acid may be used as the curing agents in accordance with the teachings herein. Other chemical structures may be combined with the phosphoric acid or acid esters to improve mechanical properties, adhesive strength, processing attributes, and cure kinetics of the formulated product. Esters with a neutral pH may also be used. In one embodiment, a carboxylic acid functional ingredient may be combined with the curatives. It is also possible that an acid anhydride can be added to the curative side of the formulation. These additives may be used because of their contribution to the final material properties or to adjust the pH of the curative part of the formulation. The use of Epodil LV5, a non-reactive xylene-formaldehyde diluent, in combination with phosphoric acid and or phosphate esters is an example. Other non-reactive additives may also be used, whether they are organic or inorganic, such as minerals. Typically, inorganic thixotropes such as fumed silica or clays are used to impart non-Newtonian rheological behavior. Organic thixotropes such as polymeric fibers may also be used.

Reacting phosphoric acid with an epoxy to form a statistically mono-substituted acid-ester, reduces the average number of reactive hydrogens to two for further epoxy reactions. In order to form a cross-linked network, the average functionality of the system needs to be greater than two, although not much greater than two is necessary. This can be accomplished by adding a small amount of un-reacted phosphoric acid, polyphosphoric acid, or polyphosphate esters to the curative, or by the use of multi-functional epoxy resins, i.e., epoxy resins with more than two oxirane rings on the molecule. Phenol novolac or cresol novolac resins can be used for this purpose. Multi-functional aliphatic resins such as epoxidized soybean oil also work. In at least one embodiment of this patent, both un-reacted phosphoric acid and multi-functional epoxy resins have been used in combination.

The one or more phosphate esters may be one or more customized phosphate esters. The one or more customized phosphate esters may be produced by the reaction of phosphoric acid and various alcohols. The one or more customized phosphate esters may be produced by the reaction of phosphoric acid and an epoxide group of a phosphate ester precursor (i.e., component not yet reacted with phosphoric acid). The one or more customized phosphate esters may be produced by the reaction of phosphoric acid with the glycidyl ether of cashew nutshell liquid (CNSL) such as that sold under the trade name Cardolite® LITE 2513HP, commercially available from Cardolite Corporation, Monmouth Junction NJ. The one or more customized phosphate esters may be produced by the reaction of phosphoric acid with a phenyl glycidyl ether such as that sold under the trade name ERISYS® GE-13, commercially available from CVC Thermoset Specialties, Moorestown, NJ. The one or more customized phosphate esters may be produced by the reaction of phosphoric acid with 2-ethylhexyl glycidyl ether such as that sold under the trade name ERISYS® GE-6, commercially available from CVC Thermoset Specialties, Moorestown, NJ. The one or more customized phosphate esters may be produced by the reaction of phosphoric acid with an epoxidized para-tertiary butyl phenol such as that sold under the trade name ERISYS® GE-11, commercially available from CVC Thermoset Specialties, Moorestown, NJ, or any other mono-functional epoxy. The one or more customized phosphate esters can be the reaction product of phosphoric acid and a mono-epoxide functional molecules in general.

The one or more phosphate esters may be one or more commercially available phosphate esters, commonly made from the reaction of various alcohols or unsaturated hydrocarbons with polyphosphoric acid and or phosphorus pentoxide. The one or more commercial phosphate esters, when swapped into the B-side in place of a customized phosphate ester may result in a curable composition that is slower reacting and foaming presumably due to a lower level of free phosphoric acid and therefore higher pH of the B-side. Reacting and foaming of the one or more commercial phosphate esters may be improved (i.e., reaction speed may be increased) by the addition of phosphoric acid in the B-side. The one or more commercial phosphate esters may have a pH of from about 1 to about 4 in aqueous solution. The one or more commercial phosphate esters may have a viscosity of about 200 cP to about 42,500 cP at 25° C. as measured according to ASTM D445. The one or more commercial phosphate esters may be a nonyl phenol ethoxylated phosphate ester. The one or more commercial phosphate esters may be a butyl phosphate ester. Examples of suitable commercial phosphate esters may be those sold under the trade names Dextrol™ OC-110, Dextrol OC-40, and Strodex MO-100 commercially available from Ashland, Inc. (Covington, KY). A further example of suitable commercial phosphate esters may be n-Butyl Acid Phosphate commercially available from IsleChem (Grand Island, NY).

The commercial phosphate esters may be present in the B-side. The one or more commercial phosphate esters may be present in an amount of about 5% to about 50% by weight of the B-side. The one or more commercial phosphate esters may be present in an amount of about 0.1% to about 30% by weight of the B-side. The one or more commercial phosphate esters may be present in an amount of about 10% to about 14% by weight of the B-side. The one or more commercial phosphate esters may be present in an amount of about 12% by weight of the B-side.

The one or more phosphate esters may be produced by a reaction of a range of stoichiometric ratios of phosphate ester precursors to phosphoric acid. The one or more phosphate esters may be produced by a reaction of about 0.7:1 phosphate ester precursor to phosphoric acid to about 1:0.7 phosphate ester precursor to phosphoric acid. The one or more phosphate esters may be produced by a reaction of about 0.8:1 phosphate ester precursor to phosphoric acid to about 1:0.8 phosphate ester precursor to phosphoric acid. The one or more phosphate esters may be produced by a reaction of about 0.9:1 phosphate ester precursor to phosphoric acid to about 1:0.9 phosphate ester precursor to phosphoric acid. The one or more phosphate esters may be produced by a reaction of about 1:1 phosphate ester precursor to phosphoric acid. The one or more phosphate esters may be produced by a reaction of about 0.8:1 phosphate ester precursor to phosphoric acid.

The one or more phosphate esters may be selected from mono-esters, di-esters, or tri-esters as shown below. The one or more phosphate esters may be a combination of mono-ester, di-ester, and tri-ester.

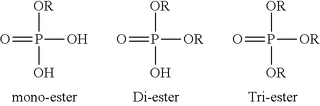

The one or more phosphate esters may be obtained from the reaction of epoxide groups with phosphoric acid as depicted below:

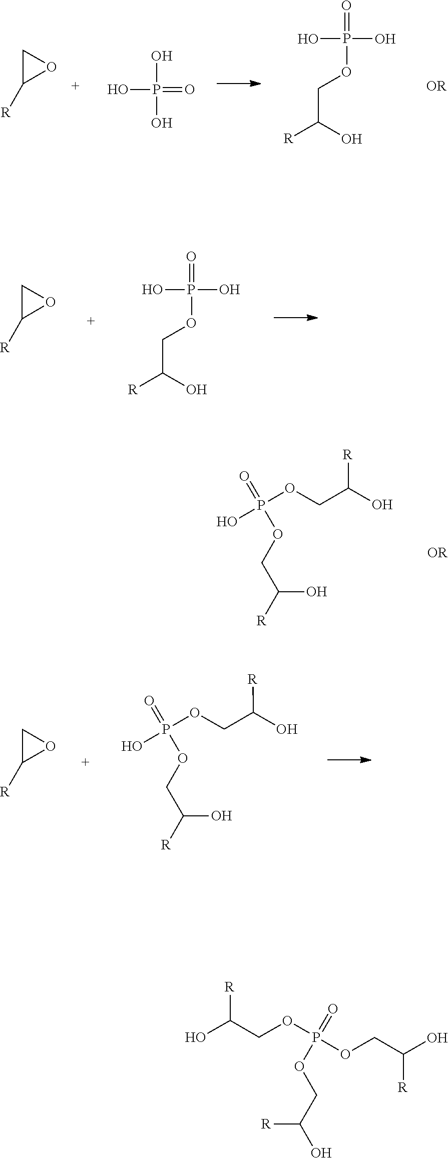

The B-side may comprise one or more phosphate esters, one or more phosphate ester precursors, or both. The B-side may comprise one or more phosphate ester precursors that may be combined with phosphoric acid prior to combination with the A-side. The B-side may comprise one or more phosphate esters that are pre-reacted (i.e., the epoxide and phosphate reaction) before addition to the B-side.

The adhesive may include more than one type of phosphate ester. At least one phosphate ester may be the reaction product of phosphoric acid with the glycidyl ether of cashew nutshell liquid (CNSL) (e.g., Cardolite® LITE 2513HP). At least one phosphate ester may be the reaction product of a stoichiometric amount of about 1:1 2-ethylhexyl glycidyl (e.g., ERISYS® GE-6) to phosphoric acid. At least one phosphate ester may be the reaction product of a stoichiometric amount of 0.8:1 phosphoric acid with 2-ethylhexyl glycidyl ether (e.g., ERISYS® GE-6). However, there are numerous possibilities for the first, second, or third phosphate ester.

At least one phosphate ester may be present in an amount of from about 10% to about 60% by weight of the B-side. At least one phosphate ester may be present in an amount from about 25% to about 35% by weight of the B-side. At least one phosphate ester may be present in an amount of from about 28% to about 32% by weight of the B-side. At least one phosphate ester may be present in an amount of about 32% by weight of the B-side. At least one phosphate ester may be present in an amount of from about 5% to about 40% by weight of the B-side. At least one phosphate ester may be present in an amount of from about 15% to about 25% by weight of the B-side. At least one phosphate ester may be present in an amount of from about 18% to about 22% by weight of the B-side. At least one phosphate ester may be present in an amount of about 21% by weight of the B-side. At least one phosphate ester may be present in an amount of from about 10% to about 65% by weight of the B-side. At least one ester may be present in an amount of from about 35% to about 45% by weight of the B-side. At least one phosphate ester may be present in an amount of about 42% by weight of the B-side. At least one phosphate ester may be present in an amount of about 58% by weight of the B-side. At least one phosphate ester may be present in an amount of about 60% by weight of the B-side.

The B-side may include phosphoric acid. The phosphoric acid may be ortho-phosphoric acid, polyphosphoric acid, or both. The phosphoric acid may be free acid in the one or more phosphate esters, added independently from the one or more phosphate esters, or both. The addition of phosphoric acid to the B-side may result in increased expansion (e.g., foaming) of the resulting reaction product. The addition of phosphoric acid to the B-side may increase the reactivity of the two-part system to help maintain desired levels of expansion, curing, or both when temperatures are below 23° C.

The independently added phosphoric acid may be in aqueous solution in the amount of 85% or more (i.e., “reagent grade”). The independently added phosphoric acid may be present in an amount of from about 1% to about 20% by weight of the B-side. The independently added phosphoric acid may be present in an amount of from about 2% to about 6% by weight of the B-side. The independently added phosphoric acid may be present in an amount of about 4% by weight of the B-side.

The one or more phosphate esters, produced from the reaction of phosphoric acid and phosphate ester precursor, may include free acid. The one or more phosphate esters may have about 1% or more free acid, about 3% or more free acid, about 5% or more free acid, about 15% or less free acid, about 13% or less free acid, or even about 11% or less free acid.

The two-part system, upon addition of the A-side and the B-side, may foam as a result of a reaction of metal carbonate or metal bicarbonate and an acid, generating the release of gas, (e.g., carbon dioxide to serve as chemical blowing agent). Such a reaction mechanism is described in U.S. Pat. No. 5,648,401, incorporated by reference herein for all purposes.

The reacting, foaming, or both may occur at a temperature of about 70° C. or less, about 50° C. or less, about 30° C. or less, about 20° C. or less, or even about 0° C. or less. The curing, foaming, or both may occur at a temperature of about 0° C. or more, about 10° C. or more, or even about 20° C. or more. The curing, foaming, or both may occur at a temperature of from about 10° C. to about 35° C. The curing, foaming, or both may occur at a temperature of about 10° C. The curing, foaming, or both may occur at room temperature (e.g., at a temperature of about 15° C. to about out 25° C.). The curing, foaming, or both may occur at a temperature of about 23° C.

The present teachings contemplate a relatively fast curing time, foaming time, or both as compared to other curing agents or curative systems that occur without the addition of a stimulus (e.g., at room temperature). The cure time of the reaction product may be 30 minutes or less, 20 minutes or less, 2 minutes or more, 8 minutes or more, or even 16 minutes or more. The cure time of the resulting reaction product may be from about 5 minutes to about 20 minutes. The cure time of the resulting reaction product may be about 10 minutes. The cure time of the resulting reaction product may be about 7 minutes. The cure time of the resulting reaction product may be about 5 minutes.

The A-side may include one or more epoxide-functional materials (i.e., one or more epoxy resins). The one or more epoxy resins may be any conventional dimeric, oligomeric, or polymeric epoxy resin. The one or more epoxy resins may contain at least one epoxide functional group (i.e., monofunctional) or may contain more than one epoxide functional group (i.e., multifunctional). The one or more epoxy resins may contain one or more epoxide functional group, two or more epoxide functional groups, three or more epoxide functional groups, or even four or more epoxide functional groups. The one or more epoxy resins may be modified epoxy resins (e.g., silane modified, elastomer modified, and the like). The one or more epoxy resins may be aliphatic, cycloaliphatic, aromatic, or the like, or any combination thereof. The one or more epoxy resins may be supplied as a solid (e.g., as pellets, chunks, pieces, or the like, or any combination thereof) or a liquid (e.g., a liquid epoxy resin). However, if solid resins are used, it is possible that they would first be dissolved in a liquid resin or other suitable solvent. As used herein, unless otherwise stated, an epoxy resin is a solid if it is solid at a temperature of 23° C. and is a liquid resin if it a liquid at a temperature of 23° C. The one or more epoxy resins may include one or more liquid epoxy resins, one or more flexible epoxy resins, one or more epoxy phenol novolac resins, one or more aliphatic multifunctional epoxy resins, one or more reactive diluents, one or more silane modified epoxy resins, or any combination thereof.

The two-part system may include one or more liquid epoxy resins. The one or more liquid epoxy resins may function as a base for the epoxy resin component. The one or more liquid epoxy resins may be a reaction product of epichlorohydrin (hereinafter, “EPH”) and any conventional bisphenol. The one or more liquid epoxy resins may be a reaction product of EPH and bisphenol A (hereinafter, “BPA”), bisphenol F (hereinafter, “BPF”), or both. The one or more liquid epoxy resins (which may be standard or commodity liquid epoxy resins) may have an epoxide equivalent weight (hereinafter “EEW”) of from about 100 g/equivalent to about 1000 g/equivalent as measured according to ASTM D1652-97. The one or more liquid epoxy resins may have an epoxide percentage of from about 20 to about 25. The one or more liquid epoxy resins may have a viscosity of from about 10 cP to about 100,000 cP at 25° C. as measured according to ASTM D445. An example of a suitable BPA-based liquid epoxy resin may be D.E.R.™ 331, commercially available from The Olin Corporation (Clayton, MO). An example of a suitable BPF-based liquid epoxy resin may be YDF-170 commercially available from Kukdo Chemical (South Korea).

The one or more liquid epoxy resins may be present as a part of the A-side. The one or more liquid epoxy resins may be present in an amount of from about 4% to about 50% by weight of the A-side. The one or more liquid epoxy resins may be present in an amount of from about 10% to about 30% by weight of the A-side. The one or more liquid epoxy resins may be present in an amount of about 8% by weight of the A-side.

Epoxy resins that result from the reaction of an epoxy with carboxyl-terminated acrylonitrile-butadiene (hereinafter “CTBN”) liquid rubber have traditionally been used to impart impact resistance to an epoxy matrix. Numerous publications inform us of their use to increase the K1C, a fracture toughness value, of a cured epoxy resin by creating discrete precipitated rubber domains within the rigid epoxy matrix. These discrete domains provide a tortuous path through the epoxy matrix for crack propagation, resulting in increased fracture resistance. They may also help to dissipate the fracture energy through crazing, the formation of multiple fractures, cavitation of the rubber particles, debonding, and void formation within the matrix. These resins typically reduce the glass transition (Tg) of the adhesive though because not all of the rubber phase separates out of the matrix, leaving some rubber reacted into the epoxy.

Epoxy functionalized molecules such as epoxy functional urethanes may also contribute to improved peel resistance. These molecules may help increase the affinity of the adhesive to certain substrates. These molecules can also increase the ability of the crosslinked network to absorb fracture energy through bending, flexing, or locally translating the molecular chain. These functionalized epoxy resins, and epoxy resins resulting from reaction products of elastomers are commonly known as modified epoxies.

Dimer fatty acids are another group of epoxidized molecules which can improve the peel resistance of an adhesive. The use of epoxidized fatty acids as epoxy tougheners and impact modifiers has increased over the last 10 years. These long-chain molecules with 36 carbon atoms in the chains, give the molecule hydrocarbon characteristics and impart lubricity and flexibility to the cross-linked network. They're hydrophobic nature tends to improve the resistance to humid environmental exposure of adhesives. Additionally, less reduction in Tg of the adhesive matrix is observed, compared to adhesives containing epoxidized CTBN.

The two-part system may include one or more flexible epoxy resins. The one or more flexible epoxy resins may function to reduce the elastic modulus, increase strain to failure, decrease time to recover, decrease the degree of cross-linking density in the reaction product, increase impact resistance, improve adhesion, improve peel resistance, or any combination thereof, of the reaction product. The one or more flexible epoxy resins may improve the gas entrapment capability of the two-part system in part by acting as a viscosity modifier or reducing gas permeability. The one or more flexible epoxy resin may be a di-functional glycidyl ether epoxy resin, a modified BPA-based epoxy resin, a multifunctional epoxidized polybutadiene resin, or any combination thereof. The one or more flexible epoxy resins may have an EEW of about 260 to about 500 as measured according to ASTM D1652-97. The one or more flexible epoxy resins may have a viscosity of about 700 cP to about 500,000 cP at 25° C. as measured according to ASTM D445. Examples of suitable flexible epoxy resins may include NC-514 (commercially available from Cardolite Corporation, Monmouth Junction NJ), Araldite® PY 4122 (commercially available from Huntsman Advanced Materials, Inc., Salt Lake City, UT), Poly bd® 605E (commercially available from Cray Valley, Exton, PA), or any combination thereof.

The one or more flexible epoxy resins may be present in the A-side. The one or more flexible epoxy resins may be present in an amount of from about 10% to about 50% by weight of the A-side. The one or more flexible epoxy resins may be present in an amount of from about 35% to about 45% by weight of the A-side. The one or more flexible epoxy resins may be present in an amount of about 39% by weight of the A-side. The one or more flexible epoxy resins may include a di-functional glycidyl ether epoxy resin in the amount of from about 10% to about 18% by weight of the A-side, an unmodified BPA-based epoxy resin in an amount of from about 8% to about 16% by weight of the A-side, and a multifunctional epoxidized polybutadiene resin in an amount of from about 8% to about 16% by weight of the A-side. The one or more flexible epoxy resins may include a di-functional glycidyl ether epoxy resin in the amount of about 14% by weight of the A-side, an unmodified BPA-based epoxy resin in an amount of about 12% by weight of the A-side, and a multifunctional epoxidized polybutadiene resin in an amount of about 12% by weight of the A-side. The two-component system may include a di-functional glycidyl ether epoxy resin, a difunctional epoxy derived from cardanol, and a multifunctional epoxidized polybutadiene resin, respectfully in a ratio of about 1:1:1. The two-component system may include a di-functional glycidyl ether epoxy resin, a difunctional epoxy derived from cardanol, and a multifunctional epoxidized polybutadiene resin, respectfully in a ratio of about 1:0.8:0.8. The two-component system may include a di-functional glycidyl ether epoxy resin, a difunctional epoxy derived from cardanol, and a multifunctional epoxidized polybutadiene resin, respectfully in a ratio of about 1:0.9:0.9.

The two-part system (adhesive) described herein may also include one or more epoxy phenol novolac resins (hereinafter “EPN”). The one or more epoxy phenol novolac resins may function to impart chemical resistance, solvent resistance, temperature resistance, or any combination thereof, to the reaction product. The one or more epoxy phenol novolac resins may be present as a part of the A-side. The one or more epoxy phenol novolac resins may have an EEW of from about 165 g/equivalent to about 183 g/equivalent as measured according to ASTM D1652-97. The one or more epoxy phenol novolac resins may have an average epoxy functionality of from about 2.1 to about 6.5. One of the primary functions of the EPN resins is to increase network crosslink density via multifunctionality. This is also important to control reaction speed and the ability to prevent foam collapse during and/or after the reaction process. The one or more epoxy phenol novolac resins may have a viscosity of from about 18,000 cP to about 30,000 cP at 25° C. as measured according to ASTM D445. Examples of suitable epoxy phenol novolac resins may be those sold under the trade names Epalloy 8250 and Epalloy 8330, commercially available from CVC Thermoset Specialties (Moorestown, NJ).

The one or more epoxy phenol novolac resins may be present in an amount of from about 30% to about 50% by weight of the A-side. The one or more epoxy phenol novolac resins may be present in an amount of about 35% to about 45% by weight of the first component or A-side. The one or more epoxy phenol novolac resins may be present in an amount of about 38% to about 42% by weight of the A-side. The one or more epoxy phenol novolac resins may be present in an amount of about 42% by weight of the A-side. The one or more epoxy phenol novolac resins may include an about 3.6 functional epoxy phenol novolac resin present in an amount of from about 2% to about 18% by weight of the A-side and an about 6.5 functional epoxy novolac resin present in an amount of from about 22% to about 32% by weight of the A-side. The one or more epoxy phenol novolac resins may include an about 3.6 functional epoxy phenol novolac resin present in an amount of about 15% by weight of the A-side and an about 6.5 functional epoxy novolac resin present in an amount of about 28% by weight of the A-side. The two-part system may include an about 3.6 functional epoxy phenol novolac resin and an about 6.5 functional epoxy phenol novolac resin at a ratio of about 1:2 to about 1:3.

Another method to increase fracture toughness of an epoxy adhesive is through the use of aliphatic epoxy resins, or resins with saturated long carbon chains between epoxy rings. Products such as Erisys EDGE from Huntsman-CVC and the Cardanol based products from Cardolite provide improved fracture resistance through their increased chain flexibility. Epoxidized oils, such as, but not limited to, soybean oil or linseed oil which can be aliphatic in nature, can provide increase in peel resistance. Additionally, long carbon chains between functional groups produce an adhesive matrix that can better conform to deformation through a large plastic deformation zone, and as a result, absorb some of the fracture energy.

The adhesive may include one or more aliphatic multifunctional epoxy resins. The one or more aliphatic multifunctional epoxy resins may function to increase the degree of cross-linking of the reaction product, increase the chemical resistance of the reaction product, or both. These resins have the ability to increase the crosslink density of the resultant reaction product while preserving or enhancing the elastomeric nature of the reaction product. The multi-functional materials may make the reaction product less elastomeric. The one or more aliphatic multifunctional epoxy resins may include an epoxidized sorbitol. The one or more aliphatic multifunctional epoxy resins may have an EEW of from about 160 g/equivalent to about 195 g/equivalent as measured according to ASTM D1652-97. The one or more aliphatic multifunctional epoxy resins may have a viscosity of from about 200 cP to about 18,000 cP at 25° C. as measured according to ASTM D445. Examples of suitable aliphatic multifunctional epoxy resins may be those sold under the trade names ERISYS® GE-60 and ERISYS® GE-61, commercially available from CVC Thermoset Specialties (Moorestown, NJ), or Epoxol 9-5, commercially available from ACS Technical Products (Griffith, IN).

The one or more aliphatic multifunctional epoxy resins may be present as a part of the A-side. The one or more aliphatic multifunctional epoxy resins may be present in an amount of from about 5% to about 20% by weight of the A-side. The one or more aliphatic multifunctional epoxy resins may be present in an amount of from about 8% to about 16% by weight of the A-side. The one or more aliphatic multifunctional epoxy resins may be present in an amount of from about 10% to about 14% by weight of the A-side. The one or more aliphatic multifunctional epoxy resins may be present in an amount of about 12% by weight of the A-side.

The adhesive may include a cashew nutshell liquid (hereinafter “CNSL”) which may include chemicals commonly extracted from cashew nutshell liquid (CNSL) including anacardic acids, cardol, cardanol, or any combination thereof. Preferably, the glycidyl ether of the cashew nutshell liquid (CNSL) is a glycidyl ether of cardanol.

Formulated materials containing cardanol derived products like those available from Cardolite such as NC-514 have also exhibited improved adhesion to metallic substates, specifically metallic substrates without surface preparation or cleaning when contaminated by organic substances. The long aliphatic chain within the molecule is thought to be capable of compatibilizing or solubilizing surface contaminants such as stamping oils, protective coatings, or mold release agents to make these surfaces more available for bonding.

The use of core-shell (hereinafter “CS”) particles also helps to reduce or retard fracture propagation through an adhesive. CS particles help increase fracture toughness much the same way as CTBN adducted epoxies, via incorporation of pre-formed elastomeric particles with a rigid shell and flexible core into a rigid matrix. However, because they do not react into the crosslinked network, typical decreases in cured Tg as seen with the use of modified or flexible epoxies, are smaller or non-existent. CS particles are particularly advantageous in rapid curing adhesives because they exist as discrete particles and do not require a secondary process such as reaction-induced phase separation (hereinafter “RIPS”) to impart toughness to a polymeric matrix. RIPS toughened adhesives generally benefit from slower reaction times which allow the secondary phase to form while the primary phase is crosslinking. Rapid reactions may not allow time for secondary phase formation. If the secondary phase does not precipitate out, it can be expected to reduce Tg and be less beneficial for physical property improvement.

The adhesive may include one or more additives. The one or more additives may include one or more toughening agents, calcium carbonate, minerals, reinforcing fiber, fumed silica, tabular alumina, or any combination thereof.

As addressed above, the adhesive may include one or more toughening agents. The one or more toughening agents may function to distribute energy within the reaction product (i.e., increase impact resistance). The one or more toughening agents may contribute to an increased T-Peel strength. The one or more toughening agents may comprise thermoplastics, thermosets or thermosettables, elastomers, the like, or any combination thereof. The one or more toughening agents may include elastomers (including elastomer containing materials), core-shell polymers (which may include but are not limited to elastomers), or both.

The core-shell polymers may comprise a first polymeric material (i.e., core material) and a second polymeric material (i.e., shell material). The first polymeric material may be entirely encapsulated by the second polymeric material. The core-shell polymer may include a first polymeric material in the amount of about 30% or more, 50% or more, or even 70% or more by weight. The first polymeric material, the second polymeric material, or both may comprise one, two, three, or even more than three polymers that are combined together, reacted together (e.g., sequentially polymerized), or both, or may be part of separate or the same core-shell polymer systems. Examples of suitable core-shell polymers may be those sold under the trade names Kane Ace™ MX-267 and MX-257, both commercially available from Kaneka North America LLC (Pasadena, TX).

The core-shell polymers may be present in an amount of from about 1% to about 25% by weight of the A-side, B-side, or both the A-side and B-side in combination (e.g., if present in the amount of 10% by weight then it may be present in an amount of 5% in the A-side and 5% in the B-side). The core-shell polymer may be present in an amount of from about 5% to about 20% by weight of the A-side, B-side, or both the A-side and B-side in combination. The core-shell polymer may be present in an amount of about 5% by weight of the A-side, B-side, or both the A-side and B-side in combination. The core-shell polymer may be present in an amount of about 17% by weight of the A-side, B-side, or both the A-side and B-side in combination.

The adhesive may include one or more reactive diluents. The one or more reactive diluents may function to reduce the overall viscosity of the two-part system, in order to modify the dispensing process or the flow of the two-part system on a workpiece after dispensing, decrease the degree of cross-linking of the reaction product when monofunctional. When statistically more than difunctional, the diluent may increase crosslink density. The one or more reactive diluents may be polymeric, whereby the reactive diluent may increase the flexibility of the reaction product; the one or more reactive diluents may be multifunctional, whereby the reactive diluent may promote increased crosslinking and impart chemical resistance on the reaction product; or both. The one or more reactive diluents may include a polyglycol diglycidyl ether, a trimethylolethane triglycidyl either, or both. The one or more reactive diluents may have an EEW of from about 100 g/equivalent to about 300 g/equivalent as measured according to ASTM D1652-97. The one or more reactive diluents may have a viscosity of about 10 cP to about 1000 cP at 25° C. as measured according to ASTM D445. An example of a suitable reactive diluents may be those sold under the trade names ERISYS® GE-31 and ERISYS® GE-24, commercially available from CVC Thermoset Specialties (Moorestown, NJ).

The one or more reactive diluents may be present in an amount of from about 5% to about 20% by weight of the A-side. The one or more reactive diluents may be present in an amount of from about 8% to about 16% by weight of the A-side. The one or more reactive diluents may be present in an amount of from about 10% to about 14% by weight of the A-side. The one or more reactive diluents may be present in an amount of about 13% by weight of the A-side. The one or more reactive diluents may include a polyglycol diglycidyl ether present in an amount of from about 2% to about 6% by weight of the A-side, and a trimethylolethane triglycidyl ether present in an amount of from about 6% to about 14% of the A-side. The one or more reactive diluents may include a polyglycol diglycidyl ether present in an amount of about 4% by weight of the A-side, and a trimethylolethane triglycidyl ether present in an amount of about 9% of the A-side. The two-part system may include a polyglycol diglycidyl ether and a trimethylolethane triglycidyl ether respectively at a ratio of about 1:2 to about 1:3.

The adhesive may include one or more epoxy functional silane or silane modified epoxy resins. The one or more epoxy functional silane or silane modified epoxy resins may function to impart improved adhesion to the reaction product, particularly adhesion to glass, metals, or both. An example of a suitable epoxy functional silane may be that sold under the trade name Silquest A-187 commercially available from Momentive Performance Materials (Albany, NY). An example of a suitable silane modified epoxy resin may be that sold under the trade name EPOKUKDO® KSR-177 commercially available from Kukdo Chemical (South Korea). Another suitable material would be a silicone pre-polymer with cycloaliphatic epoxide groups. An example of one such material is available under the trade name Silmer EPC Di-50, available from Siltech Corporation (Ontario, Canada).

The one or more silane modified epoxy resins may be present in the A-side. The one or more silane modified epoxy resins may be present in an amount of about 1% to about 15% by weight of the A-side. The one or more silane modified epoxy resins may be present in an amount of about 2% to about 6% by weight of the A-side. The one or more silane modified epoxy resins may be present in an amount of about 4% by weight of the A-side.

The adhesive may include one or more monomers. The one or more monomers may function to improve adhesion properties of the reaction product, particularly to metal substrates, increase flexibility of the reaction product, increase impact resistance of the reaction product, or any combination thereof. The one or more monomers may be monofunctional, difunctional, or even polyfunctional. The one or monomers may be an esterification reaction product of an alcohol and acrylic acid or methacrylic acid. The one or more monomers may be a monofunctional acrylic monomer. Preferably, the one or more monomers may be a mixture of methacrylate acid ester and 2-(2-ethoxyethoxy) ethyl acrylate. An example of a suitable monomer may be that sold under the trade name SR 9050 commercially available from Sartomer (Exton, PA).

The adhesive may include one or more monomers in the A-side, the B-side, or both. The one or more monomers may be present in an amount of about 0.1% to about 26% by weight of the A-side, B-side, or both the A-side and B-side in combination. The one or more monomers may be present in an amount of about 12% to about 24% by weight of the A-side, B-side, or both the A-side and B-side in combination. The one or more monomers may be present in an amount of about 14% to about 22% by weight of the A-side, B-side, or both the A-side and B-side in combination. The one or more monomers may be present in an amount of about 18% by weight of the A-side, B-side, or both the A-side and B-side in combination.

The rate of cure, the degree of crosslinking, or both may be a function of the functionality of the two-part system (A-side and B-side). A higher functionality (i.e., the average number of functional groups on one or more polymerizable components) may be desired for a two-part system having pre-polymerized components that are shorter in polymer length (i.e., lower viscosity); whereby the lack of structural backbone resulting from shorter polymers is compensated by a higher degree of crosslinking. A lower functionality may be desired for a two-part system having pre-polymerized components that are longer in length (i.e., typically resulting in higher viscosity); whereby the presence of more structural backbone resulting from longer polymers precludes the need for high functionality.

The B-side functionality may at least partially be reduced by the reaction of metal carbonate in the A side with phosphoric acid and the phosphate esters and as a result, the functionality of the B-side may be reduced. The A-side may include components with increased functionality in order to compensate for a reduced functionality of the B-side. The A-side may be formulated with increased functionality by using reactive ingredients with functionality higher than two.

As described in U.S. Pat. No. 6,730,713, when a metal carbonate is exposed to phosphoric acid and or esters of phosphoric acid in the presence of an epoxy resin, a foam can be produced via release of carbon dioxide during the curing process. A foamed adhesive or a cellular structure within the adhesive can be beneficial for the improvement of peel resistance. Cohesive failure within a foamed adhesive is generally easier to achieve because of weakening the polymeric bulk by porosity creation. Once a cohesive failure mode has been initiated, the failure mode often remains cohesive, in part because of a decreased moment arm length and change in loading angle, resulting in cracks advancing more slowly. Cohesive failure drives the fracture path through the adhesive as opposed to at the interface of the adhesive and substrate, resulting in higher resistive forces, shorter crack propagation distance, and as a result, generally higher peel strength.

The calcium carbonate and acid reaction neutralizes some of the acid. Modifying the acid equivalents of the mixed product in this manner will reduce the crosslink density of the adhesive and change the mechanical properties. Calcium carbonate or another metal carbonate can be added directly to the curative mixture to change the acidity of the mixed composition. With a fixed volumetric ratio between the resin and curative, the neutralization of acid in this manner allows for changes to be made between acid and epoxy equivalents in the mixed adhesive.

The adhesive may include one or more metal carbonates. The one or more metal carbonates may function to produce gas in the presence of an acid, act as a filler, control the onset or total extent of the foaming (e.g., expansion) process, or both. The one or more metal carbonates may be metal carbonate or metal bicarbonate. Examples of suitable fillers include calcium carbonate, nickel carbonate, barium carbonate, sodium bicarbonate, and potassium bicarbonate. Preferably the one or more metal carbonates may include calcium carbonate. The particle size of the metal carbonate, metal bicarbonate, or both may control the expansion and cure of the two-part system, whereby the total surface area of metal carbonate, metal bicarbonate, or both, available to react with the acid is a function of both the particle size of the metal carbonate, bicarbonate, or both, and the amount present in the two-part system.

The calcium carbonate may be present as one or more calcium carbonate fillers. The one or more calcium carbonate fillers may have a median particle size of from about 1 to about 50 microns. The calcium carbonate may be a medium fine particle size. For example, the median particle size of the medium fine calcium carbonate may be about 22 microns. An example of a suitable medium fine calcium carbonate may be Hubercarb® Q200, commercially available from Huber Engineered Materials (Atlanta, GA). The calcium carbonate may be a fine particle size. For example, the median particle size of the fine calcium carbonate may be about 4 microns. An example of a suitable fine calcium carbonate may be Hubercarb® Q4, commercially available from Huber Engineered Materials (Atlanta, GA). The calcium carbonate may be ultra-fine particle size. For example, the median particle size of the ultra-fine calcium carbonate may be about 1 micron. An example of a suitable ultra-fine calcium carbonate may be Hubercarb® Q2, commercially available from Huber Engineered Materials (Atlanta, GA). The two-part system may include medium fine calcium carbonate, fine calcium carbonate, ultra-fine calcium carbonate, or any combination thereof.

The calcium carbonate may be present in an amount of from about 1% to about 25% by weight of the A-side. The calcium carbonate may be present in an amount of from about 4% to about 18% by weight of the A-side. The calcium carbonate may be present in an amount of from about 8% to about 12% by weight of the A-side. The calcium carbonate may be present in an amount of about 20% by weight of the A-side. The calcium carbonate may include both a fine calcium carbonate present in an amount of from about 4% to about 8% by weight of the A-side and a medium fine calcium carbonate present in an amount of from about 13% to about 18% by weight of the A-side. The calcium carbonate may include both a fine calcium carbonate present in an amount of about 6% by weight of the A-side and a medium fine calcium carbonate present in an amount of about 15% by weight of the A-side. The calcium carbonate may include both a fine calcium carbonate present in an amount of about 5% by weight of the A-side and a medium fine calcium carbonate present in an amount of about 5% by weight of the A-side. The ratio of a medium fine calcium carbonate to a fine calcium carbonate may be about 3:1 to about 1:3. The ratio of medium fine calcium carbonate to a fine calcium carbonate may be about 1:1.

The calcium carbonate may include a coating. The coating may be any material that breaks down during the activation process, expansion process, or both, so that expansion is delayed, slowed, or both. The coating may be a wax, a fatty acid, or combinations thereof.

The adhesive may include one or more minerals. The one or more minerals (i.e., “mineral reinforcement”) may function to structurally reinforce the reaction product. The one or more minerals may improve tensile strength, the flexural strength, or both of the reaction product. The one or more minerals may be any suitable silicate minerals including but not limited to inosilicates (e.g., Wollastonite) and phyllosilicates (e.g., Kaolinite, Vermiculite, Talc, Muscovite, etc.). The characteristic external shape of an individual crystal or crystal group of the one or more minerals may be acicular or needle-like. The median particle size of the one or more minerals may be from about 10 microns to about 20 microns. The median particle size may be from about 12 microns to about 18 microns.

The adhesive may include one or more reinforcing fibers. The reinforcing fiber may function to structurally reinforce the reaction product. The one or more reinforcing fibers may improve tensile strength, flexural strength, or both of the reaction product. The one or more reinforcing fibers may be present in the A-side, the B-side, or both. The one or more reinforcing fibers may be dispersed homogenously within the A-side, the B-side, or both. The one or more reinforcing fibers may comprise polymeric fibers, glass fibers (i.e., fiberglass), or both. Polymeric fibers may include nylon, polyamide, polyester, polypropylene, polyethylene, polytetrafluoroethylene, aramid fibers (e.g., Kevlar®), the like, or any combination thereof. The glass fibers may include alumino-borosilicate glass (“E-glass”), alkali-lime glass (“A-glass” or “C-glass”), electrical/chemical resistance glass (“E-CR-glass”), borosilicate glass (“D-glass”), alumino-silicate glass (“R-glass” or “S-glass”), or any combination thereof. The reinforcing fiber may be chopped fiber. The reinforcing fiber may be chopped to a length of about 0.1 cm or more, about 0.3 cm or more, or even about 0.6 cm or more. The reinforcing fiber may be chopped to a length of about 2.0 cm or less, about 1.5 cm or less, or even about 1.0 cm or less. Examples of suitable fiberglass may be chopped strands commercially available from Jushi USA (Columbia, SC).

The reinforcing fiber may be present in the amount of from about 0.01% by weight to about 3% by weight of the A-side, B-side, or both the A-side and B-side in combination. The reinforcing fiber may be present in the amount of from about 0.1% by weight to about 1% by weight A-side, B-side, or both the A-side and B-side in combination. The reinforcing fiber may be present in the amount of about 0.2% by weight A-side, B-side, or both the A-side and B-side in combination. The two-part system may include one or more thixotropes to control viscosity.

The two-part system may include hydrophobic silica. The hydrophobic silica may function to control viscosity (e.g., thicken), control thixotropy, boost hydrophobia, or a combination thereof. The hydrophobic silica may be fumed silica. The hydrophobic silica may be surface treated. For example, the hydrophobic silica may be fumed silica surface-treated with polydimethylsiloxane (hereinafter “PDMS”) or hexamethyldisilazane (hereinafter “HMDZ”). The hydrophobic silica may be present as part of the A-side, the B-side, or both. Examples of suitable hydrophobic silica may be that sold under the trade name AEROSIL® R 202 commercially available from Evonik Corporation (Parsippany, NJ); and those sold under the trade name CAB—O-SIL® TS-530 and TS-720 commercially available from Cabot Corporation (Boston, MA).

The hydrophobic silica may be present in an amount of about 0.25% to about 6% by weight of the A-side, B-side, or both the A-side and B-side in combination. The hydrophobic silica may be present in an amount of about 0.5% to about 4% by weight of the A-side, B-side, or both the A-side and B-side in combination. The hydrophobic silica may be present in an amount of from about 1% to about 2% by weight of the A-side, B-side, or both the A-side and B-side in combination. The hydrophobic silica may be present in an amount of from about 0.5% to about 2% by weight of the A-side. The hydrophobic silica may be present in an amount of from about 3% to about 5% by weight of the B-Side. The ratio of hydrophobic silica in the A-side to the B-side may be from about 1:6 to about 6:1. The ratio of hydrophobic silica in the A-side to the B-side may be about 1:4. The ratio of hydrophobic silica in the A-side to the B-side may be about 1:2 to about 2:1.

The two-part system may include tabular alumina. The tabular alumina may function to impart hardness, resistance to thermal shock, resistance to mechanical shock, high heat capacity, high electrical resistance, or any combination thereof, to the reaction product. The tabular alumina may be present in the A-side, the B-side, or both. The tabular alumina may be alpha alumina converted to its corundum form (i.e., crystalline aluminum oxide) and sintered and may be provided as graded granules or powders. The tabular alumina may be graded (i.e., separated by size) from about 44 microns to about 4760 microns. The tabular alumina may be graded to about 44 microns.

The tabular alumina may be present in an amount of from about 0.1% to about 15% by weight A-side, B-side, or both the A-side and B-side in combination. The tabular alumina may be present in an amount of from about 4% to about 12% by weight A-side, B-side, or both the A-side and B-side in combination. The tabular alumina may be present in an amount of about 5% by weight A-side. The tabular alumina may be present in an amount of about 10% by weight A-side.

The adhesive may include one or more functional additives for improving one or more various properties of the composition. Examples of suitable functional additives may include antioxidants, antiozonants, ultraviolet absorbers, antistatic agents, colorants, coupling agents, curing agents, flame retardants, blowing agents, heat stabilizers, impact modifiers, lubricants, plasticizers, preservatives, processing aids, stabilizers, the like, and any combination thereof.

The viscosity of the A-side, the B-side, or both may be high enough at about 23° C. in order to preclude the two-part system from undesirably flowing into areas adjacent the dispensed bead upon dispensing the two-part system on a workpiece or to control flow (i.e., permit a desired amount of flow) into areas adjacent the dispensed bead upon dispensing the two-part system. The viscosity of the A-side, B-side, or both, needed to preclude undesirable flow or control flow may depend on the size of the bead dispensed. For example, the thicker the bead of the two-part system dispensed, the higher the viscosity needed to preclude unintended flow or control flow. The viscosity of the A-side at 23° C. may be from about 5,000 cP to about 50,000 cP or even from about 35,000 cP to about 45,000 cP at very low shear rates that approximate sag conditions. The viscosity of the A-side and B-side at 23° C. may be from about 250,000 cP to about 400,000 cP. The viscosity of the A-side at 10° C. may be from about 280,000 cP to about 350,000 cP or even from about 300,000 cP to about 325,000 cP. The viscosity of the B-side at 23° C. may be from about 2,500 cP to about 50,000 cP or even from about 35,000 cP to about 45,000 cP. The viscosity of the B-side at 10° C. may be from about 130,000 cP to about 220,000 cP or even from about 175,000 cP to about 195,000 cP.

The adhesive may foam, upon mixing the A-side and B-side, more than about 50%, more than about 100%, more than about 200%, less than about 800%, less than about 700%, or even less than about 600% the two-part system's original volume. The two-part system may expand from about 400% to about 500% the two-part system's original volume. The two-part system may expand about 100% the two-part system's original volume. The adhesive may be substantially free of any foaming.

The adhesive may be free of curing agents (i.e., conventional curing agents), curing accelerators, or both. Typical curing agents include lewis bases (i.e., anionic catalysts), lewis acids (i.e., cationic catalysts), UV catalysts, amines, anhydrides, phenols, thiols, or any combination thereof. In place of the aforementioned curing agents, the two-part system may cure upon a polymerization reaction, catalyzed by phosphoric acid, between phosphate esters and epoxide groups, hydroxy groups, or both. The two-part system may be both cured and caused to expand by the chemical interaction between phosphate ester and metal carbonate. It has been found that utilizing the cure and expansion system of the present disclosure may reduce the complexity of formulations by reducing the number of overall components (i.e., curing agents, curing accelerators, and blowing agents); however, the achievement of a desired expansion and time to cure is made more challenging to optimize.

The two-part system may be mixed together at a ratio of from 1:4 to 4:1, A-side to B-side. The two-part system may be mixed together at a ratio of from 1:2 to 2:1, A-side to B-side. The two-part system may be mixed together at a ratio of 1:1, A-side to B-side. The two-part system may be mixed together at a ratio of 2:1, A-side to B-side.

The adhesive may be cured and/or expanded before or after full assembly of the workpieces upon which the adhesive is applied. For example, the adhesive may be dispensed upon a first workpiece, cured and/or expanded, and then a second workpiece, complementary to the first workpiece, may be applied upon the first workpiece. As another example, the adhesive may be dispensed upon a first workpiece, a second workpiece complementary to the first workpiece may be applied upon the first workpiece, and then the two-part system may be cured and/or expanded. An adhesive that cures and/or expands after the full assembly of the workpiece may expand to fill a space between a first workpiece and a second workpiece. The first workpiece, the second workpiece, or both may include grooves in which the adhesive is dispensed in, expands in, or both. The two-component material may be dispensed in a cavity.

Table 1 provides test results for typical commercially available 5-minute epoxy adhesives. T-Peel resistance is measured as the average of the force required to separate bonded substrates at 1800 from each other divided by the bond width and often given in units of newtons per millimeter (N/mm) or pounds per inch (lb/in) as per ASTM D1876. T-Peel samples are tested at 100 mm/min. Lap shear samples, tested following EN 2243-1, are tested at 50 mm/min. Tensile samples are tested at 10 mm/min following ISO 527. The Tg values were obtained from the peak of G prime, as opposed to Tan delta, measured by DMA. This value indicates where material properties will start to change.

TABLE 1
Physical properties of commercially available rapid cure structural adhesive materials

| | JB Weld - Clear | | Gorilla Glue | Scotch Weld |
|---|---|---|---|---|
| Product | Weld | Devcon 5 min | 5 min Epoxy | DP100NS |
| Stress at Break (MPa) | 13.1 | | 14.5 | 25.3 |
| Modulus (MPa) | 282 | | 485 | 1883 |
| Strain at Break (%) | 71.9 | 1% from TDS | 34.8 | 5.5 |
| Tg - G′ (° C.) | 30.66 | 45.21 | 37.47 | 48.52 |

Lap Shear - Clean (25.4 × 12.7 × 0.25) m

| | | | | |
|---|---|---|---|---|
| E-Coat ES-27 @ 1.6 mm (MPa) | 23.2 | 4.66 | 12.5 | 10.01 |
| Failure Mode | AF | AF | AF | AF |
| HS EG-60 @ 1.6 mm (MPa) | 7.63 | 5.67 | 10.34 | 6.47 |
| Failure Mode | AF | AF | AF | AF |
| Al 6022 @ 0.95 mm (MPa) | 9.63 | 2.48 | 3.34 | 1.9 |
| Failure Mode | AF | AF | AF | AF |

T-Peel - Clean (75 × 25.4 × 0.25) m

| | | | | |
|---|---|---|---|---|
| E-Coat ES-27 @ 0.7 mm | Fragile Bond | Fragile Bond | 0.57 | Fragile Bond |
| (N/mm) | | | | |
| Failure Mode | AF | AF | AF | AF |
| EG-60 @ 0.7 mm (N/mm) | 0.69 | Fragile Bond | 0.5 | Fragile Bond |
| Failure Mode | AF | AF | AF | AF |
| Al 6022 @ 0.95 mm (N/mm) | 0.42 | Fragile Bond | Fragile Bond | Fragile Bond |
| Failure Mode | AF | AF | AF | AF |

Lap shear results are very good for E-coated steel specimens of JB Weld but reduced significantly for galvanized and aluminum substrates. Lap shear results for the Devcon 5-minute, Gorilla glue 5 minute, and Scotch Weld are less than what would be expected of a structural adhesive.

As per the test standard, peel strength is calculated from the average force per unit width after the first 10 mm of displacement from the initial peak force. A fragile T-Peel bond represents rapid and sudden debonding of the substrates before this displacement can be reached or very soon afterward. The failure mode is represented by the percent cohesive failure (CF), cohesive failure is represented by near equal amounts of the adhesive remaining attached to each substrate after testing. Superficial cohesive failure (TCF) is classified when the bulk of the adhesive remains on one substrate, but a film or thin coating of adhesive remains on the second substrate. Adhesive failure (AF) is defined when the bulk of the adhesive remains bonded to one substrate and no adhesive remains on the second.

The following examples describe the use of phosphoric acid and or phosphate esters and or other acidic constituents as the primary curatives with a mixture containing epoxide functional materials including bisphenol-A, bisphenol-F, aliphatic, and elastomer-modified epoxies as the primary resins, to produce 2-component, ambient temperature cured adhesives with some epoxide functionality characterized in particular by improved T-Peel resistance.

TABLE 2

| | | | | | | |
|---|---|---|---|---|---|---|
| Example | 1 | 2 | 3 | 4 | 5 | 6 |

Resin (A side)

| | | | | | | |
|---|---|---|---|---|---|---|
| KSR177 | 21.90 | 22.46 | 23.07 | 23.16 | 21.92 | 21.92 |
| Epalloy 8250 | 18.62 | 19.00 | 19.60 | 19.60 | 18.62 | 18.62 |
| Epotec YD-134 | 5.00 | 5.10 | 5.26 | | 5.00 | |
| DER 732 | | | | | | 5.00 |
| Cardolite NC-514 | 16.59 | 16.93 | 17.44 | 17.46 | 16.57 | 16.57 |
| Epokukdo UME-330 | 7.55 | 7.70 | 7.95 | 7.95 | 7.55 | 7.55 |
| Epoxol 9-5 | 5.00 | 5.10 | | 5.26 | | 5.00 |
| Kukdo KF Epiol-PE 510 | | | | | 5.00 | |
| Kane Ace MX257 | 18.24 | 18.61 | 19.20 | 19.20 | 18.24 | 18.24 |
| Hubercarb Q200 | 2.00 | | 2.11 | 2.11 | 2.00 | 2.00 |
| Halox SZP-391 | 4.00 | 4.08 | 4.21 | 4.21 | 4.00 | 4.00 |
| Fumed Silica | 1.00 | 1.02 | 1.05 | 1.05 | 1.00 | 1.00 |
| Colorant | 0.10 | 0.10 | 0.11 | 0.10 | 0.10 | 0.10 |
| Total | 100.00 | 100.10 | 100.00 | 100.10 | 100.00 | 100.00 |

Curative (B side)

| | | | | | | |
|---|---|---|---|---|---|---|
| H3PO4 85% wt. | 12.50 | 12.50 | 12.50 | 12.50 | 12.50 | 12.50 |
| L&L PE02 | 70.65 | 70.65 | 70.65 | 70.65 | 70.65 | 70.65 |
| Carboxylic Acid | 10.00 | 10.00 | 10.00 | 10.00 | 10.00 | 10.00 |
| Terminated Polymer | | | | | | |
| Vansil HR2000 | 4.75 | 4.75 | 4.75 | 4.75 | 4.75 | 4.75 |
| Garamite 1958 | 2.00 | 2.00 | 2.00 | 2.00 | 2.00 | 2.00 |
| Colorant | 0.10 | 0.10 | 0.10 | 0.10 | 0.10 | 0.10 |
| Total | 100.00 | 100.00 | 100.00 | 100.00 | 100.00 | 100.00 |
| Volumetric Mix Ratio | 4:1 | 4:1 | 4:1 | 4:1 | 4:1 | 4:1 |
| A:B | | | | | | |
| Tensile Peak Stress | 35.8 | 28 | 35.1 | 19.83 | 13.1 | 17.1 |
| (MPa) | | | | | | |
| Tensile Modulus (MPa) | 1670 | 1337 | 1992 | 1135 | 1515 | 778 |
| Tensile Elongation (%) | 4.2 | 5.99 | 2.34 | 3.05 | 0.97 | 19.5 |

Lap Shear - Clean (25.4 × 12.7 × 0.25) m

| | | | | | | |
|---|---|---|---|---|---|---|
| HS EG-60 @ 1.6 mm | 19.7 | 20.87 | 22.21 | 16.89 | 17.32 | 17.29 |
| (MPa) | | | | | | |
| Failure Mode | 40% TCF | 100% CF | 83% CF | 40% CF | 95% CF | 100% CF |

T-Peel - Clean (75 × 25.4 × 0.25) m

| | | | | | | |
|---|---|---|---|---|---|---|
| E-Coat ES-27 @ 0.7 mm | 5.51 | Fragile Bond | 3.92 | 3.56 | Fragile Bond | Fragile Bond |
| (N/mm) | | | | | | |
| Failure Mode | 100% TCF | Stick/slip | 63% CF | Stick/slip | 18% TCF | Stick/slip |
| EG-60 @ 0.7 mm | 5.46 | 2.92 | 3.52 | 3.65 | 2.35 | 4.65 |
| (N/mm) | | | | | | |
| Failure Mode | 100% CF | 100% TCF | 100% TCF | 100% CF | 100% TCF | 100% CF |
| Al 6022 @ 0.95 mm | 5.03 | 2.98 | 2.8 | 2.77 | 2.45 | 3.54 |
| (N/mm) | | | | | | |
| Failure Mode | 100% TCF | 100% TCF | 100% TCF | 100% TCF | 100% TCF | 67% TCF |

Table 2 contains formulation examples with changes in the epoxy containing A side and a common curative B side. Though the examples contain many components described herein and are considered within the scope of the current teachings, Example 1 shows some superior physical characteristics when compared to Examples 2-6. In Example 1 we observe peel values of at least 5 N/mm with cohesive or thin-cohesive failure modes on a variety of substrates. Reduced peel values are obtained in Example 2 with the lack of calcium carbonate, despite the failure mode remaining cohesive for some substrates. On the electrocoated steel substrate, the adhesive fails before any measurable peel was obtained, signified by a fragile bond. The stick/slip failure mode signals peel performance with areas of highly variable bond strength.

Calcium carbonate can reduce the cohesive strength within the resin matrix, producing a failure within the adhesive instead of at the interface of the adhesive and the substrate. The reaction of calcium carbonate with the acidic curative will consume some of the acidic reactive sites, presumably producing less overall cross-linking in the system. This reaction will most likely also slow the cross-linking reaction by reacting the most acidic hydrogen atoms first as well as produce carbon dioxide gas. A slower cross-linking rate allows more time for wet-out of the adhesive to the substrates and creating a cellular structure within the adhesive, both tend to improve peel resistance.

In Example 3, the multifunctional aliphatic resin is removed with all ingredient percentages increased proportionally with the removal of the constituent, compared to Example 1. This results in an increase in lap shear value, but peel values are lower and tensile elongation is also reduced while the tensile modulus is increased. The overall strength of the system is reduced in Example 4 compared to Example 1, when one of the bis-A epoxy resins is removed. Reduced tensile properties as well as reduced lap shear and peel values are observed. In Example 5, the system exhibits more fragile peel response as demonstrated by the reduction of all the measured peel values. In this batch the multi-functional epoxidized linseed oil is replaced by a multi-functional epoxidized sorbitol. In Example 6 compared to Example 1, a bis-A epoxy resin is replaced with an epoxidized polypropylene glycol. Comparing Example 6 to Example 1, there is a decrease in tensile modulus and a significant increase in elongation. A general decrease in adhesive strength as well as fragile behavior in peel on electrocoated steel is also measured. Comparing Example 6 with Example 4, where the epoxidized polypropylene glycol is added to the example, tensile modulus once again decreases with an increase in elongation. Once again, the peel performance on electrocoated steel is decreased, however, slight increases in lap shear and peel on the other substrates are observed.

TABLE 3

| | | | |
|---|---|---|---|
| Example | 7 | 8 | 9 |

Resin (A side)

| | | | |
|---|---|---|---|
| KSR177 | 22.00 | 19.60 | |
| Epalloy 8250 | | 21.20 | 17.27 |
| Kukdo YDF-170 | | | 25.10 |
| Epotec YD-134 | 5.00 | 4.55 | |
| Cardolite NC-514 | 16.59 | 14.85 | |
| Cardolite NC-514S | | | 3.65 |
| Hypox UA-10 | | | 8.11 |
| Epokukdo UME-330 | 7.55 | 7.55 | |
| Epilox E50-20 | | | 14.84 |
| Epoxol 9-5 | 23.62 | 7.00 | |
| Erisys GE-60 | | | 9.31 |
| Kane Ace MX257 | 18.24 | 18.25 | 20.72 |
| Hubercarb Q200 | 2.00 | 2.00 | |
| Halox SZP-391 | 4.00 | 4.00 | |
| Fumed silica | 1.00 | 1.00 | 1.00 |
| Total | 100.00 | 100.00 | 100.00 |

Curative (B side)

| | | | |
|---|---|---|---|
| H3PO4 85% wt. | 12.50 | 12.50 | 12.50 |
| L&L PE02 | 70.75 | 70.75 | 51.39 |
| Carboxylic Acid Terminated | 10.00 | 10.00 | 28.22 |
| Polymer | | | |
| Vansil HR2000 | 4.75 | 4.75 | 5.76 |
| Garamite 1958 | 2.00 | 2.00 | 2.05 |
| Total | 100.00 | 100.00 | 100.00 |
| Volumetric Mix Ratio A:B | 4:1 | 4:1 | 4:1 |

Lap Shear - Clean (25.4 × 12.7 × 0.25) m

| | | | |
|---|---|---|---|
| HS EG-60 @ 1.6 mm (MPa) | 18.54 | 24.31 | 17.07 |
| Failure Mode | 40% TCF | 84% TCF | 98% TCF |

T-Peel - Clean (75 × 25.4 × 0.25) m

| | | | |
|---|---|---|---|
| E-Coat ES-27 @ 0.7 mm (N/mm) | 3.38 | 4.54 | 5.14 |
| Failure Mode | 5% E-Coat Failure | 47% TCF | 55% CF with E- |
| | 95% AF | | Coat Failure |
| EG-60 @ 0.7 mm (N/mm) | 6.1 | 3.69 | 2.17 |
| Failure Mode | 87% CF | 100% TCF | 50% CF |
| Al 6022 @ 0.95 mm (N/mm) | 3.64 | 2.46 | 2.83 |
| Failure Mode | AF | 100% TCF | 62% CF |

In Examples 7 and 8, the influence of the epoxidized linseed oil on the adhesive properties is evaluated. In Example 7, all of the phenol novolac resin has been replaced by the epoxidized linseed oil. This increases the overall crosslink density of the system, however, with a more molecular-mobile resin then the novolac. Failure mode in peel is shifted toward adhesive failure, and generally, strength is lower. A 2000 increase in epoxidized linseed oil as shown in Example 8 compared to Example 1, provides a significant increase in lap shear values, but decreases peel results. Failure modes however remain cohesive at this level compared to Example 7.

Example 9 represents another embodiment of the current teachings. As with previous examples, phosphoric acid and the esters of phosphoric acid are used to crosslink a mixture of aromatic, aliphatic, and impact modified epoxies in combination with CS particles, to produce an adhesive with improved peel resistance. Example 9 demonstrates another ratio of phosphoric acid to esterified acid used to produce these types of adhesives. These ratios are changed in part by the use of a carboxylic acid terminated polymer.

TABLE 4

| | | | | | |
|---|---|---|---|---|---|
| Example | 10 | 11 | 12 | 13 | 14 |

A side

| | | | | | |
|---|---|---|---|---|---|
| KSR177 | 23.70 | 27.92 | 23.69 | 23.79 | 21.74 |
| Epalloy 8250 | 20.15 | 23.75 | 20.14 | 20.25 | 18.48 |
| Epotec YD-134 | 5.42 | 6.38 | 5.41 | 5.41 | 4.96 |
| Epokukdo YD-128 | 11.49 | | | | |
| Cardolite NC-514 | 17.95 | | 17.94 | 18.00 | 16.47 |
| Epokukdo UME-330 | 8.18 | 9.63 | | | 7.49 |
| Epoxol 9-5 | 5.42 | | 5.41 | 5.41 | 4.96 |
| Kane Ace MX257 | | 23.26 | 19.73 | 19.80 | 18.11 |
| Hubercarb Q200 | 2.17 | 2.55 | 2.16 | 2.16 | 1.99 |
| Halox SZP-391 | 4.33 | 5.10 | 4.33 | 4.33 | 3.97 |
| MiniFibers Shortstuff | | | | 0.74 | 0.74 |
| ESS2F | | | | | |
| Fumed Silica | 1.08 | 1.28 | 1.08 | | 0.99 |
| Colorant | 0.11 | 0.13 | 0.11 | 0.11 | 0.10 |
| Total | 100.00 | 100.00 | 100.00 | 100.00 | 100.00 |

B side

| | | | | | |
|---|---|---|---|---|---|
| H3PO4 85% wt. | 12.50 | 12.50 | 12.50 | 12.50 | 12.5 |
| L&L PE02 | 70.65 | 70.65 | 70.65 | 70.90 | 68.9 |
| Carboxylic Acid | 10.00 | 10.00 | 10.00 | 10.00 | 10 |
| Terminated Polymer | | | | | |
| Vansil HR2000 | 4.75 | 4.75 | 4.75 | 4.75 | 4.75 |
| Garamite 1958 | 2.00 | 2.00 | 2.00 | | 2 |
| MiniFibers Shortstuff | | | | 1.75 | 1.75 |
| ESS2F | | | | | |
| Colorant | 0.10 | 0.10 | 0.10 | 0.10 | 0.10 |
| Total | 100.00 | 100.00 | 100.00 | 100.00 | 100.00 |
| Volumetric Mix Ratio | 4:1 | 4:1 | 4:1 | 4:1 | 4:1 |
| (A:B) | | | | | |
| Tensile Peak Stress | 20.3 | 13.9 | 19.3 | 13.67 | 12.57 |
| (MPa) | | | | | |
| Tensile Modulus | 1280 | 1715 | 1184 | 856 | 771 |
| (MPa) | | | | | |
| Tensile Elongation | 3.04 | 1.06 | 2.78 | 3.92 | 4.71 |
| (%) | | | | | |

Lap Shear - Clean (25.4 × 12.7 × 0.25

| | | | | | |
|---|---|---|---|---|---|
| HS EG-60 @ 1.6 mm | 18.28 | 11.12 | 16.04 | 20.82 | 19.55 |
| (MPa) | | | | | |
| CF (%) | 10% CF | 100% CF | 100% CF | 20% CF | 67% CF |

T-Peel - Clean (75 × 25.4 × 0.25

| | | | | | |
|---|---|---|---|---|---|
| E-Coat ES-27 @ | Fragile | Fragile | Fragile | 0.7 | Fragile |
| 0.7 mm (N/mm) | | | | | |
| CF (%) | AF | TCF | AF | 7% CF | AF |
| EG-60 @ 0.7 mm | 1.77 | 1.14 | 1.94 | 3.93 | 3.7 |
| (N/mm) | | | | | |
| CF (%) | 100% TCF | 20% CF | AF | 67% CF | 93% CF |
| Al 6022 @ 0.95 mm | Fragile | Fragile | 1.47 | 1.46 | 2.61 |
| (N/mm) | | | | | |
| CF (%) | 92% TCF | TCF | TCF | 13% CF | 63% CF |

In Examples 10 through 12 of Table 4, the importance of the ingredients is evaluated by systematically removing them. In Examples 13 and 14, the effect of polymeric fibers on the adhesive's performance is evaluated. In Example 10, the CS is removed compared to Example 1, with other ingredient percentages allowed to remain at the same relative ratios to each other. Because the Kane Ace product is a dispersion of 37% CS in liquid epoxy resin, YD-128 has been added to the formulation to compensate the loss of resin. Without CS particles the adhesive is more brittle. A higher tensile modulus is measured with increased lap shear and significantly decreased peel performance. Lower cohesive failure is also noted.

Compared to Example 1, all aliphatic epoxy resins are removed from Example 11. A significant increase in tensile modulus and decrease in tensile elongation is measured. The adhesive performance in both lap shear and T-Peel is also reduced significantly on every substrate. In Example 12, the epoxidized urethane resin is removed compared to Example 1. All measured properties are lower.

The fumed silica in the resin side and Garamite in the curative side is removed from Example 12 and mostly replaced by polymeric fibers to produce Example 13. Increased lap shear and peel performance, especially on galvanized steel, are measured. Example 14 was produced by adding the fibers to both A and B sides of Example 1. In this example, lap shear values remain similar, but both tensile and T-Peel performance is reduced.

The present teachings provide a method that may comprise: providing a two-part system, the two-part system including an A-side (i.e., first component) and a B-side (i.e., second component). The A-side including one or more epoxy resins and the B-side including one or more phosphate esters and optionally phosphoric acid. The A-side and the B-side may be mixed to form a curable composition. The method may include a step of curing the curable composition at a temperature of less than 50° C., thereby forming a reaction product. The method may comprise a step of mixing the first component and the second component to form a reaction prod. The method may comprise a step of curing wherein the reaction product of the first component and the second component cures at a temperature of less than 50° C. The method may be employed with an A-side that includes one or more epoxy resins, calcium carbonate, or both. The method may be employed with a B-side that includes one or more phosphate esters, phosphoric acid, or both. The method may be employed with an A-side, a B-side, or both having one or more additives.

As used herein, unless otherwise stated, the teachings envision that any member of a genus (list) may be excluded from the genus; and/or any member of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the range in terms of “at least ‘x’ parts by weight of the resulting composition” also contemplates a teaching of ranges of same recited amount of “x” in percent by weight of the resulting composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints. Unless otherwise stated, a teaching with the term “about” or “approximately” in combination with a numerical amount encompasses a teaching of the recited amount, as well as approximations of that recited amount. By way of example, a teaching of “about 100” encompasses a teaching of 100.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist of, or consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1: A curable adhesive formulation comprising:
a part A with one or more epoxy resins;
a part B with an acidic phosphoric constituent;
wherein the adhesive includes one or more of calcium carbonate, minerals, reinforcing fibers, hydrophobic silica, or any combination thereof; and
wherein the cured adhesive provides for assemblies that have a lap shear of at least about 15 MPa as measured in accordance with EN 2243-1.

2: A curable adhesive formulation comprising:
a part A with one or more epoxy resins;
a part B with an acidic phosphoric constituent;
wherein the cured adhesive has a T-Peel of at least about 2.5 N/mm as measured in accordance with ASTM D1876.

3: The adhesive of claim 2, wherein the cured adhesive provides for assemblies that have a lap shear of at least about 15 MPa as measured in accordance with EN 2243-1.

4: The adhesive of claim 1, wherein the acidic phosphoric constituent comprises one or more phosphate esters, phosphoric acid, polyphosphoric acid, phosphorus pentoxide, or any combination thereof.

5. (canceled)

6: The adhesive of claim 4, wherein the one or more phosphate esters independently of one another are the reaction products of phosphoric acid and
an alcohol;
an epoxide group of a phosphate ester precursor (i.e., component not yet reacted with phosphoric acid);
a mono-epoxide functional molecule;
a glycidyl ether of cashew nutshell liquid (CNSL);
a phenyl glycidyl ether;
2-ethylhexyl glycidyl ether;
an epoxidized para-tertiary butyl phenol.

7-10. (canceled)

11: The adhesive of claim 1, wherein part B comprises one or more non-phosphorous containing acids or derivatives, one or more acid anhydride, one or more additives, one or more monomers, or any combination thereof.

12. (canceled)

13: The adhesive of claim 11, wherein the adhesive includes calcium carbonate.

14: The adhesive of claim 11, wherein the adhesive includes an elastomeric material.

15. (canceled)

16: The two-part system of claim 11, including calcium carbonate present in an amount of from about 1% to about 25% by weight of the part A.

17. (canceled)

18: The adhesive of claim 11, including hydrophobic silica.

19: The adhesive of claim 11, including tabular alumina.

20-21. (canceled)

22: The adhesive of claim 1, including one or more liquid epoxy resins that are, independently of one another, a reaction product of epichlorohydrin and a bisphenol.

23: The adhesive of claim 22, wherein the one or more liquid epoxy resins have
an epoxide equivalent weight of from about 100 g/equivalent to about 1000 g/equivalent as measured according to ASTM D1652-97;
an epoxide percentage of from about 20 to about 25; and/or
a viscosity of from about 10 cP to about 100,000 cP at 25° C. as measured according to ASTM D445.

24. (canceled)

25: The adhesive of claim 2, wherein the one or more epoxy resins include one or more flexible epoxy resins independently of one another selected from di-functional glycidyl ether epoxy resin, modified BPA-based epoxy resins, multifunctional epoxidized polybutadiene resins, or any combination thereof.

26: The adhesive of claim 25, wherein the one or more flexible epoxy resins independently of one another have
an epoxide equivalent weight of about 260 to about 500 as measured according to ASTM D1652-97; and/or
a viscosity of about 700 cP to about 500,000 cP at 25° C. as measured according to ASTM D445.

27-32. (canceled)

33: The adhesive of claim 2, wherein the one or more epoxy resins include epoxidized sorbitol.

34-41. (canceled)

42: The adhesive of claim 1, wherein the cured adhesive has a tensile modulus of at least 1000 MPa as measured in accordance with ISO 527.

43-44. (canceled)

45: The adhesive of claim 42, wherein part A and part B are substantially free of any fiber material.

46. (canceled)

47: The adhesive of claim 1, wherein part A includes an epoxidized linseed oil in an amount of greater than 0.5% but less than 10%.

48-50.

[symbol]

51: The adhesive of claim 1, wherein part A includes bisphenol A epoxy and an epoxidized linseed oil in a ratio of from about 1 part bisphenol A epoxy:2 parts epoxidized linseed oil to from about 2 parts bisphenol A epoxy:about 1 part epoxidized linseed oil.

52-59. (canceled)
